(19) United States
(12) Patent Application Publication
(10) Pub. No.: US 2020/0076591 A1
(43) Pub. Date: Mar. 5, 2020

(54) Systems and Methods for Automated Generation and Update of Cipher Parameters

(71) Applicant: BPRK LLC, Newark, DE (US)

(72) Inventors: Peter David Baker, Lakewood, CA (US); Susan L. Baker, Leander, TX (US)

(21) Appl. No.: 16/122,720

(22) Filed: Sep. 5, 2018

(51) Int. Cl. H04L 9/08; H04L 9/06; H04L 29/06

(52) U.S. Cl. CPC H04L 9/0869; H04L 63/0428; H04L 9/0894; H04L 9/0656

(57) ABSTRACT

Systems and methods for encrypting and decrypting data during an active data communication are disclosed. In one embodiment, seed data is received. A number of first seed bits are extracted from the seed data. The extracted first seed bits is used to index into a first index location of first one-time pad (OTP) data and obtain system setup random data from the first OTP data. System configuration information including a number of cipher parameters is defined based on the system setup random data, where the number of cipher parameters includes encryption cipher parameters and decryption cipher parameters. The data is encrypted or decrypted based, respectively, at least on the encryption cipher parameters or the decryption cipher parameters to generate encrypted data or decrypted data respectively.

### FIELD OF THE INVENTION

Embodiments of the present disclosure relate generally to data encryption and decryption. More particularly, embodiments of the disclosure relate to systems and methods for automated generation and update of cipher parameters.

### BACKGROUND

With the continuing growth of the distribution and storage and/or transfer of information in ever expanding methodologies, there is an increasing amount of content being distributed, shared, and stored. Such content, therefore, can be maliciously accessed, modified, and inappropriately distributed.

Data encryption using ciphers and one-time pad (OTP) have been used for the protection of content, but they have not been completely secured. In order to increase protection of encrypted data, there is a need to improve the way encryption is applied. While various forms of encryption have been utilized to protect data, the data is typically protected using fixed encryption/cipher parameters. Thus, when unauthorized access to the data occurs, all information being protected is compromised, such as an entire database.

The requirement of a user input and/or knowledge of passwords are also known weaknesses in the protection of encrypted data. Those seeking to defeat an encryption system, if they gain access to a password, code, or other input, would have access to a complete copy of an encrypted file. Once the data is compromised, it is difficult to trace the distribution of the compromised information.

### BRIEF DESCRIPTION OF THE DRAWINGS

Embodiments of the disclosure are illustrated by way of example and not limited to the figures of the accompanying drawings in which like references indicate similar elements.

FIG. 1 is a block diagram illustrating a communication system according to one embodiment.

FIG. 2 is a block diagram illustrating an example of an OTP service engine operating on a communication system according to one embodiment.

FIG. 3 is a block diagram illustrating an example of an interaction among a password file and OTP files according to one embodiment.

FIG. 4 is a flow diagram illustrating a method to retrieve seed data from seed/password file according to one embodiment.

FIG. 5 is a flow diagram illustrating a method of updating cipher parameters according to one embodiment.

FIG. 6 is a flow diagram illustrating another method of updating cipher parameters according to one embodiment.

FIG. 7 is a block diagram illustrating a data processing system according to one embodiment.

### DETAILED DESCRIPTION

Various embodiments and aspects of the disclosure will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present disclosure. However, in certain instances, well-known or conventional details are not described in order to provide a concise discussion of embodiments of the present disclosure.

Reference in the specification to “one embodiment” or “an embodiment” means that a particular feature, structure, or characteristic described in conjunction with the embodiment can be included in at least one embodiment of the disclosure. The appearances of the phrase “in one embodiment” in various places in the specification do not necessarily all refer to the same embodiment.

According to one aspect, seed data is received. A number of first seed bits are extracted from the seed data. The extracted first seed bits is used to index into a first index location of first one-time pad (OTP) data and obtain system setup random data from the first OTP data. System configuration information including a number of cipher parameters is defined based on the system setup random data, where the number of cipher parameters includes encryption cipher parameters and decryption cipher parameters. The data is encrypted or decrypted based, respectively, at least on the encryption cipher parameters or the decryption cipher parameters to generate encrypted data or decrypted data respectively.

In one embodiment, whether the number of cipher parameters is to be updated is determined based on a parameter update rate included in the defined system configuration information. Some or all of the number of cipher parameters are automatically updated in response to determining that the number of cipher parameters is to be updated.

In another embodiment, to automatically update some or all of the number of cipher parameters, the extracted first seed bits are used to further obtain, from the first OTP data, a starting index of second OTP data. The starting index of the second OTP data is used to index into a first index location of the second OTP data and obtain one or more first random numbers from the second OTP data. Some or all of the encryption cipher parameters are updated with first new encryption parameter values computed using the first random number(s) from the second OTP data.

In yet another embodiment, to automatically update some or all of the number of cipher parameters, the extracted first seed bits are used to further obtain, from the first OTP data, a starting index of third OTP data. The starting index of the third OTP data is used to index into a first index location of the third OTP data and obtain one or more first random numbers from the third OTP data. Some or all of the decryption cipher parameters are updated with first new decryption parameter values computed using the first random number(s) from the third OTP data.

In still another embodiment, the number of first seed bits is permanently deleted from the seed data after use.

In one embodiment, whether the number of cipher parameters is to be updated is again determined based on the parameter update rate included in the defined system configuration information. In response to determining that the number of cipher parameters is to be updated, one or more second random numbers are sequentially retrieved from the second OTP data based on a second index location of the second OTP data located immediately after the first random number(s). Some or all of the encryption cipher parameters are updated with second new encryption parameter values computed using the second random number(s) from the second OTP data.

In another embodiment, whether the number of cipher parameters is to be updated is again determined based on the parameter update rate included in the defined system configuration information. In response to determining that the number of cipher parameters is to be updated, one or more second random numbers are sequentially retrieved from the third OTP data based on a second index location of the third OTP data located immediately after the first random number(s). Some or all of the decryption cipher parameters are updated with second new decryption parameter values computed using the one or more second random numbers from the third OTP data.

The foregoing embodiments of the disclosure (which are discussed in more detail herein below) can allow for multiple encryption/decryption ciphers and parameters to be used and updated randomly during an active data communication. Moreover, the embodiments of the disclosure can eliminate the need for a user input (e.g., input password) and/or knowledge of a password or other input parameters used in the encryption and decryption of information. In addition, multiple encryption and decryption algorithms (or ciphers) may be used and updated to limit or minimize access, and mitigate loss of data in the event of an unauthorized access from an intruder. In some embodiments, aspects of the disclosure also can eliminate the need for public keys.

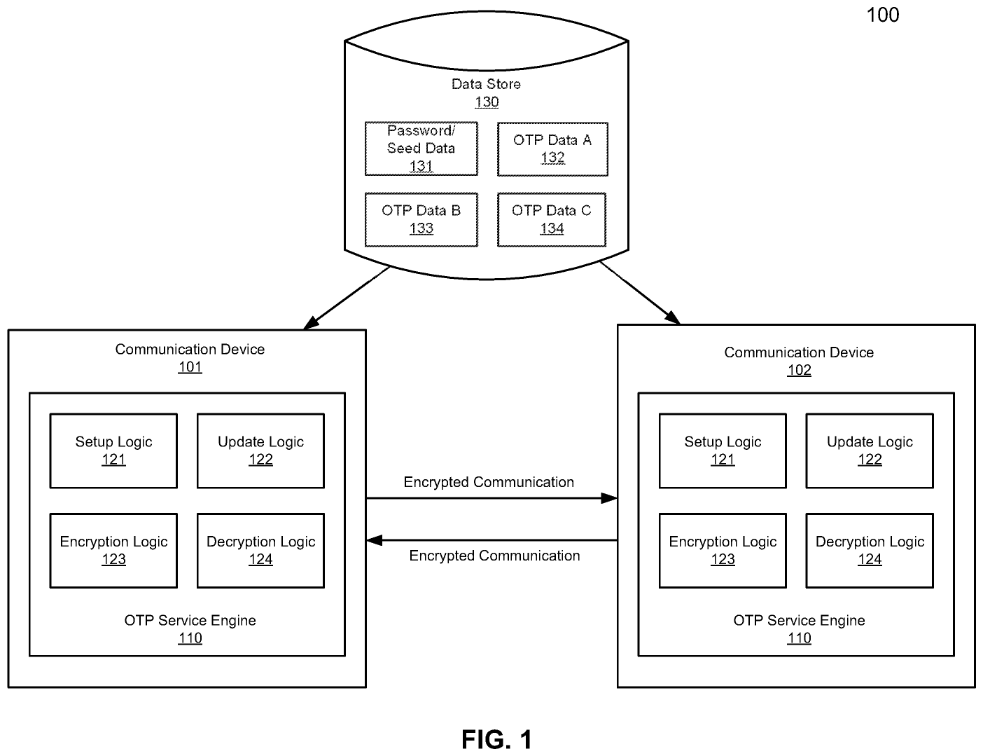

FIG. 1 is a block diagram illustrating a communication system according to one embodiment. Referring to FIG. 1, system 100 includes, but is not limited to, communication devices 101-102 communicatively coupled (or connected) to one another. Communication devices 101-102 may be any type of devices such as a host or server, a personal computer (e.g., desktops, laptops, and tablets), a “thin” client, a personal digital assistant (PDA), a Web enabled appliance, a mobile phone (e.g., smartphone), wearable device (e.g., smartwatch), etc. Alternatively, any of devices 101-102 may be a primary storage system (e.g., local data center) that provides storage to other local clients, which may periodically back up the content stored therein to a backup storage system (e.g., a disaster recovery site or system). Although not shown in FIG. 1, in one embodiment, communication devices 101-102 may be communicatively coupled to one another over a network, such as a local area network (LAN), a wide area network (WAN) such as the Internet, a fiber network, a storage network, or a combination thereof, wired or wireless. Devices 101-102 may be in physical proximity or may be physically remote from one another.

With continued reference to FIG. 1, devices 101-102 may be coupled to data store 130 (e.g., a database) over the network, as previously described. As shown, data store 130 may store or include password (or seed data) 131, first one-time pad (OTP) data 132 (also referred to as OTP data A), second OTP data 133 (also referred to as OTP data B), and third OTP data 134 (also referred to as OTP data C). In one embodiment, data store 130 may be stored on server or a cluster of one or more servers (e.g., cloud servers) such that it can be accessed over the network to retrieve seed data 131, first OTP data 132, second OTP data 133, and third OTP data 134. In another embodiment, data store 130 may be deployed and stored locally on each of devices 101-102 using, for example, a persistent storage device, such as a universal serial bus (USB) flash drive, an external hard drive, or an external solid state drive (SSD). In yet another embodiment, seed data 131, first OTP data 132, second OTP data 133, and third OTP data 134 may be generated on each of the communication devices 101-102, for example, by a built-in random number generator installed on the communication device.

Still referring to FIG. 1, each of devices 101-102 may include an OTP service engine 110 installed thereon. OTP service 110 may include setup logic 121, update logic 122, encryption logic 123, and decryption logic 124. Setup logic 121 is configured to define overall system encryption/decryption configuration information for devices 101-102. For example, setup logic 121 may retrieve (or receive) seed data 131, first OTP data 132, second OTP data 133 and third OTP data 134 from data store 130. In one embodiment, seed data 131 may include a number of passwords or seeds, where each password (e.g., a predetermined or computed number of seed bits) is used to index into an index location of first OTP data 132. That is, the password, which may be of any length and value, may be used as an index to obtain system setup random data (e.g., one or more random numbers or values) in first OTP data 132. In one embodiment, the system setup random data may be used to define the overall system encryption/decryption configuration information. That is, the system setup random data of first OTP data 132 may be used to setup cipher information. More specifically, the system setup random data may be used to define or setup a parameter update rate, a number of ciphers used for encryption and decryption, which and ciphers to use for encryption and decryption (e.g., Rivest-Shamir-Adleman (RSA), Data Encryption Standard (DES), Blowfish, Twofish, Advanced Encryption Standard (AES), etc.), which cipher parameters to update or vary (e.g., a subset of the cipher parameters or all of the cipher parameters), and/or initialization values for encryption and decryption cipher parameters. In one embodiment, the encryption and decryption cipher parameters (depending on a particular cipher) may include, but not limited to, a selected cipher for encryption/decryption, mode, block size, initialization vector or nonce, key, key size, etc. In one embodiment, the system setup random data of first OTP data 132 may be used to generate one or more cipher keys or sub-keys (e.g., symmetric key, asymmetric key, public key and/or private key) in accordance with the specific cipher's key generation procedures. In another embodiment, setup logic 121 may perform manual setup of system and cipher parameters at startup (or construction) time. For example, a user of communication device 101 may communicate on-the-fly predetermined system and cipher parameters to a user of communication device 102 (e.g., via a secure communication, such as an encrypted email), or vice versa. Using the predetermined system and cipher parameters, setup logic 121 may define the overall system encryption/decryption configuration information for devices 101-102, as previously described. In this way, a secure communication between devices 101-102 may be performed when seed data 131 is unavailable.

Based on the parameter update rate included in the cipher information, update logic 122 may update certain encryption/decryption cipher parameters as defined by the system setup random data, such as a selected cipher (or algorithm) to use for encryption/decryption, mode (e.g., encryption, decryption), block size, initialization vector or nonce, key, key size, etc. (as previously described). In one embodiment, the parameter update rate may also be included in the cipher parameters. Thus, in this embodiment, the parameter update rate may also be updated with a new update rate by update logic 122. In one embodiment, the parameter update rate may be a predetermined data transfer byte count, that when reached, update logic 122 may generate and/or update new parameter values for the cipher parameters during an active or live communication using second OTP data 133 (for encryption) and third OTP data 134 (for decryption). In this way, multiple sets of cipher parameters are used during an active communication (i.e., multiple encryption/decryption algorithms), and the requirement of a user input (e.g., an input password) or knowledge of a password is eliminated. Thus, this enhances the protection of the active communication from an intruder.

Encryption logic 123 may encode or encrypt an outgoing message or information (i.e., plaintext) based on the cipher parameters and/or generated encryption keys or sub-keys so as to generate encrypted information (i.e., ciphertext). The encrypted information may then be transmitted from device 101 to device 102 (or vice versa), such as a full-duplex or half-duplex transmission. Correspondingly, when encrypted information (or ciphertext) is received, for example by device 101 or device 102, decryption logic 124 may decode or decrypt the encrypted information using the cipher parameters and/or generated decryption keys or sub-keys so as to generate decrypted information (i.e., plaintext) that may be subsequently processed.

It should be appreciated that while FIG. 1 illustrates communication devices 101-102 in system 100, alternative embodiments may include any number of communication devices in system 100.

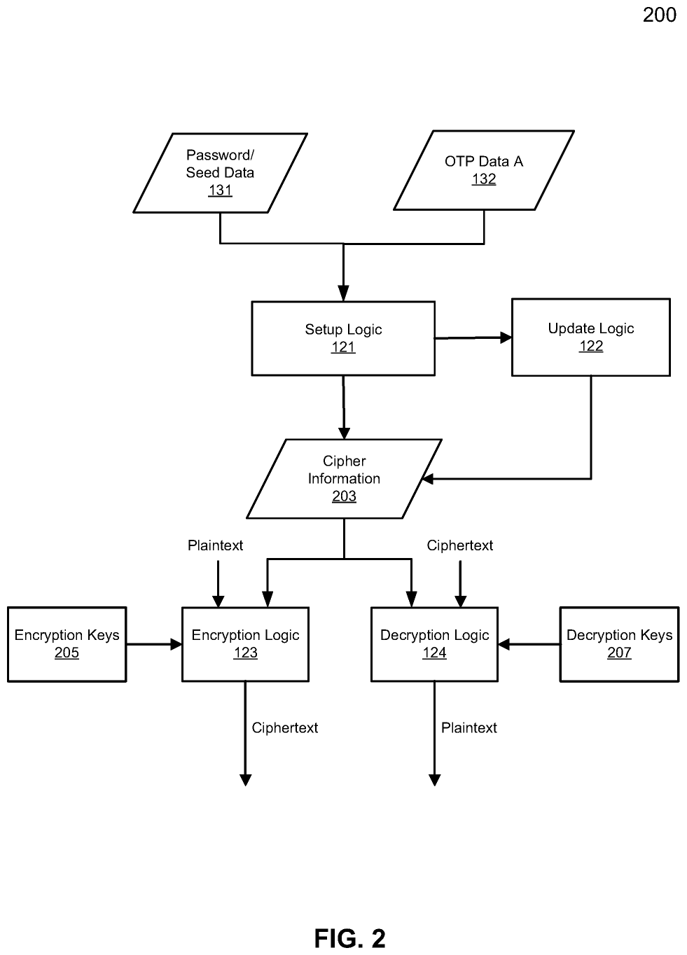

FIG. 2 is a block diagram illustrating an example of an OTP service engine operating on a communication system according to one embodiment. In FIG. 2, OTP service engine 200 may include setup logic 121, encryption logic 123, and decryption logic 124, which have been previously described, and for brevity sake, they will not be described in detail again.

As previously described, setup logic 121 may retrieve a seed (or password) included in seed data 131, and the seed may be utilized as an index to obtain system setup random data from first OTP data 132. Using the system setup random data, setup logic 121 may setup or define cipher information 203, which may include, but not limited to, a parameter update rate, a number of ciphers used for encryption/decryption, which ciphers to use for encryption/decryption (e.g., RSA, DES, Blowfish, Twofish, AES, etc.), which cipher parameters to update or vary (e.g., a selected cipher, mode, block size, initialization vector or nonce, key, key size, etc.), and/or an initialization values for encryption and decryption cipher parameters. In one embodiment, based on the ciphers, the system setup random data may also be utilized to generate one or more encryption keys (or sub-keys) 205 (e.g., symmetric key, asymmetric key, private key and/or public key) and one or more decryption keys (or sub-keys) 207 (e.g., symmetric key, asymmetric key, private key and/or public key) using specific cipher key generation procedures, although the keys may be pre-generated in alternative embodiments. In some embodiments, encryption keys 205 and decryption keys 207 may be the same keys, for example, in the case of symmetric encryption/decryption.

Update logic 122 may update certain encryption/decryption cipher parameters in cipher information 203 when it is determined that those parameters are to be updated (e.g., based on the parameter update rate). As previously described, update logic 122 may generate and/or update new parameter values for the cipher parameters during an active or live communication using second OTP data 133 (for encryption) and third OTP data 134 (for decryption).

Using cipher information 203 and encryption keys 205, encryption logic 123 may encrypt outgoing plaintext to produce ciphertext (or encrypted data), which may be communicated to a communication device (e.g., device 101 or 102). Correspondingly, using cipher information 203 and decryption keys 207, decryption logic 124 may decrypt incoming ciphertext to produce plaintext (or decrypted data), which may be used for subsequent processing, for example to ascertain the actual data content within the ciphertext. In one embodiment, the outgoing plaintext and incoming ciphertext may be any type of data, such as audio data, video data, audiovisual data, image data, text data, etc.

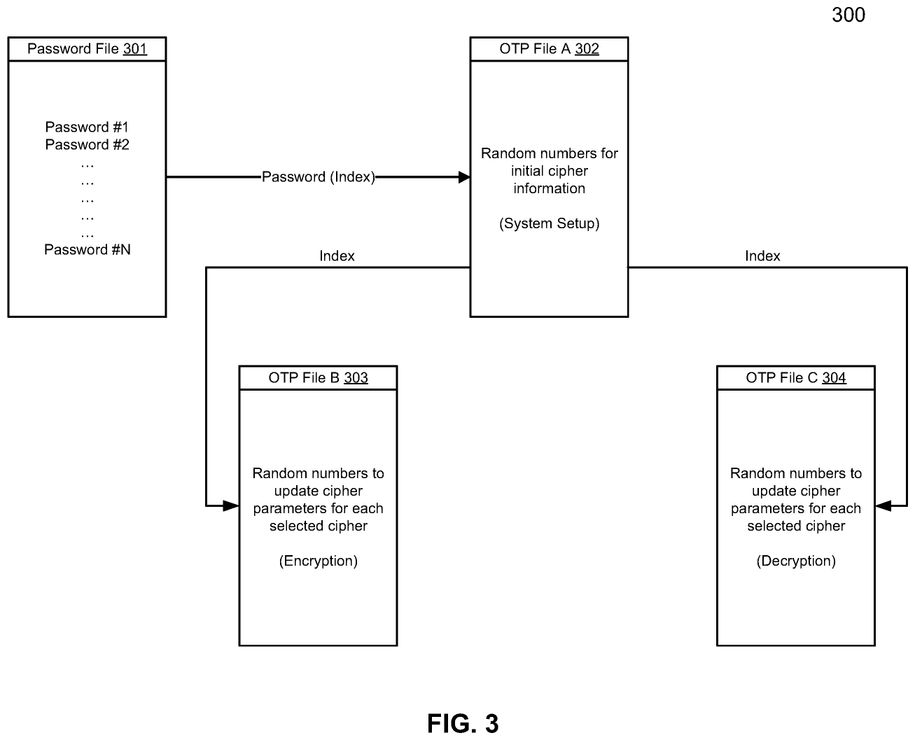

FIG. 3 is a block diagram illustrating an example of an interaction among a seed/password file and OTP files according to one embodiment. In FIG. 3, interaction 300 may include a password file 301, first OTP file 302, second OTP file 303, and third OTP file 304. In one embodiment, password file 301 may include seed data 131, and first OTP file 302, second OTP file 303, and third OTP file 304 may respectively include first OTP data 132, second OTP data 133, and third OTP data 134 of FIG. 1. Accordingly, as shown, password file 301 may include a number of passwords (or seeds), such as Password 1 . . . Password N, where N is any positive integer. Setup logic 121 may extract a first password (e.g., any of Password 1 . . . Password N) from password file 301, and using the first password as an index, setup logic 121 may index into a first index location and obtain, from first OTP file 302, system setup random data (e.g., one or more random numbers) and starting indices of second and third OTP files 303-304. The system setup random data may then be used to determine initial cipher information (as previously described). In one embodiment, the extracted first password may be a predetermined (or computed or user supplied) number of seed bits.

Based on a parameter update rate (e.g., a predetermined data transfer byte count) included in the cipher information, update logic 122 may update cipher parameters selected to be randomly updated or varied (e.g., encryption/decryption parameters) included in the cipher information during an active or live communication. For instance, on the encryption side, using the starting index of the second OTP file 303, update logic 122 may index into an index location of second OTP file 303 and obtain one or more random numbers (also referred to as cipher configuration numbers) from second OTP file 303. The random numbers from the second OTP file 303 may then be utilized to compute new encryption cipher parameter values for the encryption cipher parameters. The encryption parameters therefore may be updated (or replaced) with the newly computed values, and encryption logic 123 may encrypt outgoing plaintext using the updated encryption parameters. Correspondingly, on the decryption side, using the starting index of the third OTP file 304, update logic 122 may index into an index location of third OTP file 304 and obtain one or more random numbers (also referred to as cipher configuration numbers) from the third OTP file 304. The random numbers from the third OTP file 304 may then be utilized to compute new decryption cipher parameter values for the decryption cipher parameters. The decryption parameters therefore may be updated (or replaced) with the new parameter values, and decryption logic 124 may decrypt incoming ciphertext using the updated decryption parameters.

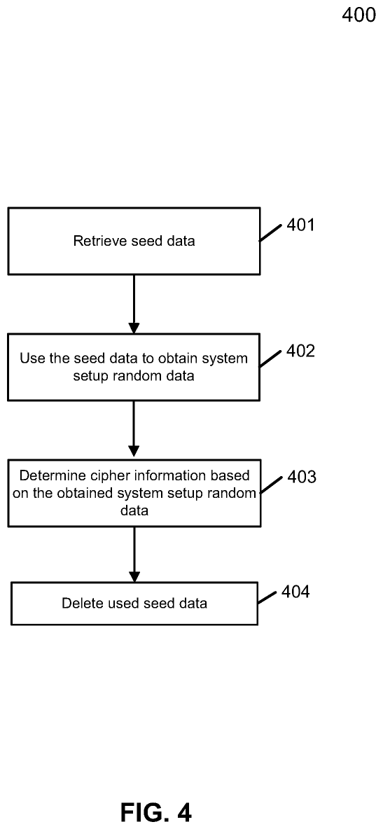

FIG. 4 is a flow diagram illustrating a method to retrieve seed data from seed/password file. Process 400 may be performed by processing logic that includes hardware (e.g. circuitry, dedicated logic, etc.), software (e.g., embodied on a non-transitory computer readable medium), or a combination thereof. For example, process 400 may be performed by communication device 101 or 102 of FIG. 1 (e.g., setup logic 121). In one embodiment, process 400 may be performed by an active end or passive end of system 100. An active end refers to a communication device (e.g., device 101 or 102) that initiates a connection request, whereas a passive end refers to a communication device that receives the connection request.

Referring to FIG. 4, at block 401, the processing logic retrieves seed data (e.g., seed data 131 of FIG. 1). For example, the seed data 131 may be retrieved from data store 130 over a network, or locally on communication device 101 or 102. As previously described, seed data 131 may include a number of passwords or seeds that are used to index into a number of unique index locations of first OTP data 132. At block 402, the processing logic uses the seed data to obtain system setup random data (e.g., one or more random numbers). For example, a first password or seed (e.g., a predetermined or computed number of seed bits) from seed data 131 may be extracted and utilized to index into a first index location of first OTP data 132 to obtain the system setup random data. At block 403, the processing logic determines cipher information based on the system setup random data. For instance, the system setup random data may be used to define values for the cipher information that includes a parameter update rate, a number of ciphers used for encryption/decryption, which ciphers to use for encryption/decryption (e.g., RSA, DES, Blowfish, Twofish, AES, etc.), which cipher parameters to randomly update or vary (e.g., a selected cipher, mode, block size, initialization vector or nonce, key, key size, etc.), and/or an initialization values for encryption and decryption cipher parameters. At block 404, the processing logic permanently deletes the used seed data (e.g., the retrieved first password from seed data 131).

With respect to the foregoing embodiments described in FIG. 4, as the first password or seed is permanently deleted after it is used, in a new or subsequent line of communication, a new and unique password (i.e., a new index) may be extracted from seed data 131 to index into a new index location and obtain, from first OTP data 132, new system setup random data and starting indices of second and third OTP data 133-134. The new starting indices of second and third OTP data 133-134, therefore, are also different starting indices as compared to the previous indices obtained using the first password. As such, new and unique random number(s) are obtained respectively from second and third OTP data 133-134 to update cipher parameters (as previously described and also described in more detail herein below), thereby enhancing the protection of data communication between devices 101-102.

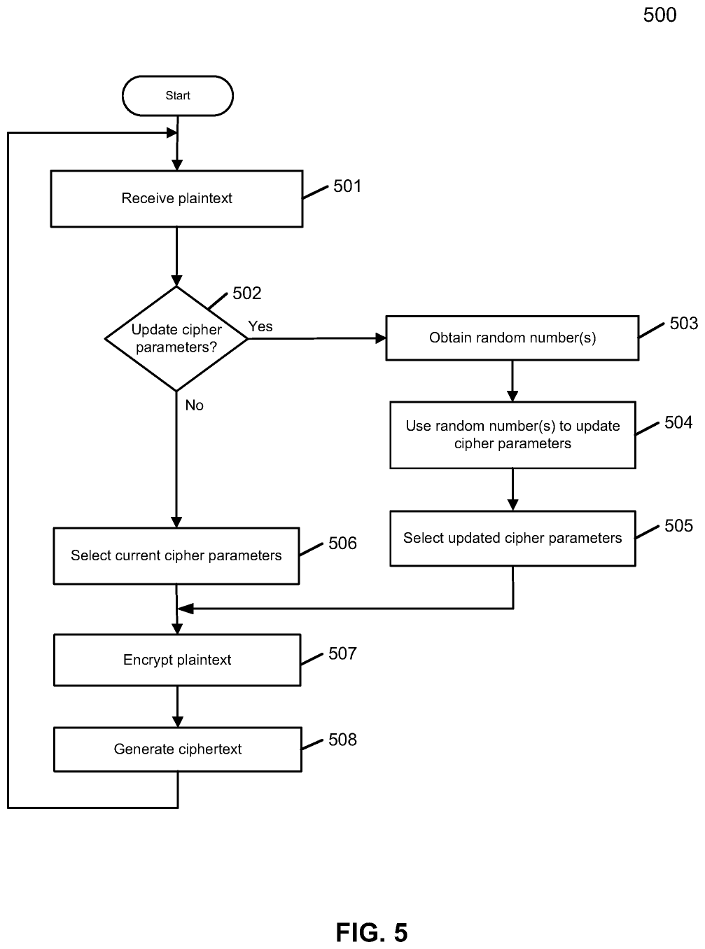

FIG. 5 is a flow diagram illustrating a method of updating cipher parameters according to one embodiment. Process 500 may be performed by processing logic that includes hardware (e.g. circuitry, dedicated logic, etc.), software (e.g., embodied on a non-transitory computer readable medium), or a combination thereof. For example, process 500 may be performed by communication device 101 or 102 of FIG. 1 (e.g., update logic 122 and/or encryption logic 123).

Referring to FIG. 5, at block 501, during an active or live communication, the processing receives plaintext (e.g., outgoing message or information). At block 502, the processing logic determines whether to update cipher parameters (e.g., encryption parameters), where the cipher parameters are included in the cipher information determined by setup logic 121 (as previously described). To determine whether to update the cipher parameters, the processing logic may determine whether a parameter update rate/interval has expired. In one embodiment, the parameter update rate/interval may be an encryption byte count. If the byte count has been reached or exceeded, for example, the processing logic may determine to update the cipher parameters selected to be updated or varied, and proceed to block 503. Otherwise, the processing logic proceeds to block 506 where the processing logic selects the current cipher parameters. At block 503, the processing logic obtains one or more random numbers. For example, in one embodiment using a starting index of second OTP data 133, which may be obtained from first OTP data 132, the processing logic may index into an index location of second OTP data 133 and obtain the random number(s) from second OTP data 133. In another embodiment, in a subsequent update (e.g., when the cipher parameters are again determined to need to be updated in block 502), new random number(s) may be sequentially retrieved from second OTP data 133 starting at an index location located immediately after the previous random number(s) retrieved from second OTP data 133, instead of using the starting index of the second OTP data 133. At block 504, the processing logic uses the random number(s) from second OTP data 133 to automatically update the cipher parameters. For example, based on the random number(s), the processing logic may compute new parameter values for the cipher parameters, and the cipher parameters therefore may be updated with the new values. In this way, multiple encryption algorithms can be used and the need for public keys can be eliminated, thereby mitigating the loss of data in the event of an unauthorized access. At block 505, the processing logic selects the updated cipher parameters. At block 507, the processing logic encrypts outgoing plaintext using either the selected updated cipher parameters or the current cipher parameters to generate ciphertext (at block 508). The processing logic then repeats the process and loops back to block 501 until the communication is terminated.

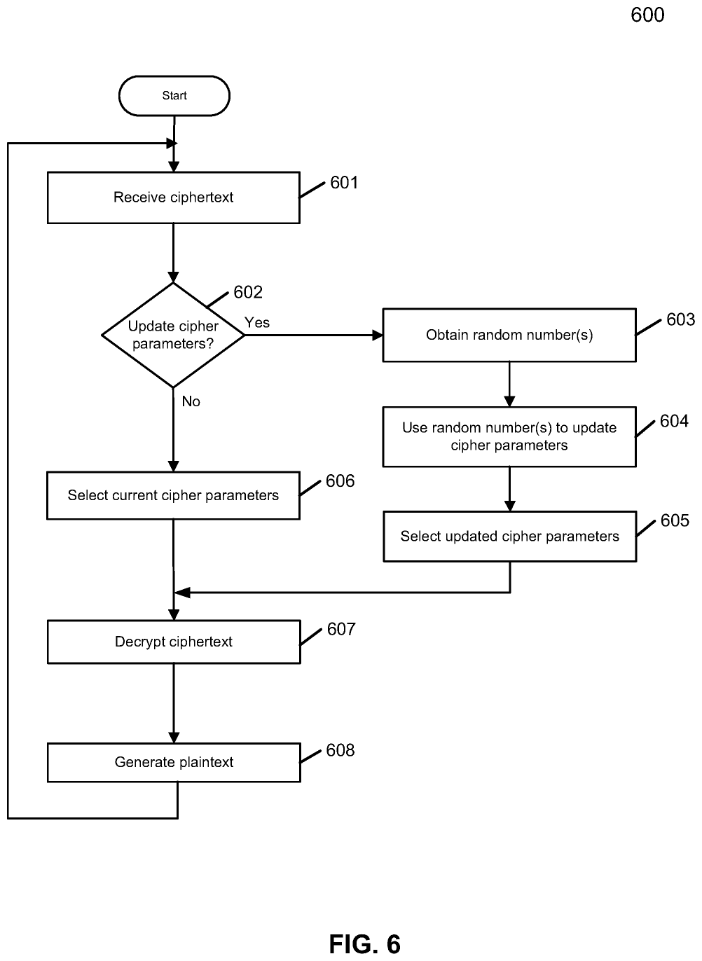

FIG. 6 is a flow diagram illustrating another method of updating cipher parameters according to one embodiment. Process 600 may be performed by processing logic that includes hardware (e.g. circuitry, dedicated logic, etc.), software (e.g., embodied on a non-transitory computer readable medium), or a combination thereof. For example, process 600 may be performed by communication device 101 or 102 of FIG. 1 (e.g., update logic 122 and/or decryption logic 124).

Referring to FIG. 6, at block 601, the processing receives ciphertext (e.g., incoming encrypted message or information). At block 602, the processing logic determines whether to update cipher parameters (e.g., decryption parameters), where the cipher parameters are included in the cipher information determined by setup logic 121 (as previously described). To determine whether to update the cipher parameters, the processing logic may determine whether a parameter update rate/interval (which may be a decryption byte count) has expired. If the byte count has been reached or exceeded, the processing logic may determine to update the cipher parameters, and proceed to block 603. Otherwise, the processing logic proceeds to block 606 where the processing logic selects the current cipher parameters. At block 603, the processing logic obtains one or more random numbers. For example, using a starting index of third OTP data 134, which may be obtained from first OTP data 132, the processing logic may index into an index location of third OTP data 134 and obtain the random number(s) from the third OTP data 134. In another embodiment, in a subsequent update (e.g., when the cipher parameters are again determined to need to be updated in block 602), new random number(s) may be sequentially retrieved from third OTP data 134 starting at an index location located immediately after the previous random number(s) retrieved from third OTP data 134, instead of using the starting index of the third OTP data 134. At block 604, the processing logic uses the random number(s) from the third OTP data 134 to automatically update the cipher parameters. For example, based on the random number(s), the processing logic may compute new parameter values for the cipher parameters, and the cipher parameters therefore may be updated with the new parameter values. At block 605, the processing logic selects the updated cipher parameters. At block 607, the processing logic decrypts incoming ciphertext using either the selected updated cipher parameters or the current cipher parameters to generate plaintext (at block 608). The processing logic then repeats the process and loops back to block 601 until the communication is terminated.

Note that some or all of the components as shown and described above (e.g., content store 115 of FIG. 1) may be implemented in software, hardware, or a combination thereof. For example, such components can be implemented as software installed and stored in a persistent storage device, which can be loaded and executed in a memory by a processor (not shown) to carry out the processes or operations described throughout this application. Alternatively, such components can be implemented as executable code programmed or embedded into dedicated hardware such as an integrated circuit (e.g., an application specific IC or ASIC), a digital signal processor (DSP), or a field programmable gate array (FPGA), which can be accessed via a corresponding driver and/or operating system from an application. Furthermore, such components can be implemented as specific hardware logic in a processor or processor core as part of an instruction set accessible by a software component via one or more specific instructions.

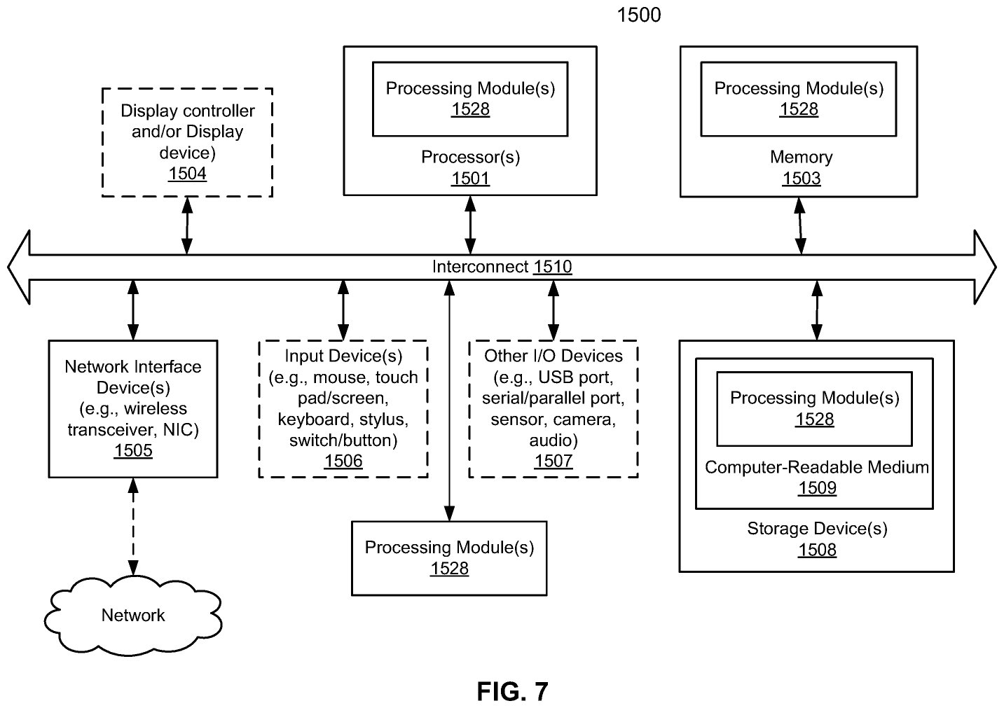

FIG. 7 is a block diagram illustrating an example of a data processing system which may be used with one embodiment. For example, system 1500 may represent any of data processing systems described above (e.g., communication devices 101-102 of FIG. 1) performing any of the processes or methods described above. System 1500 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 1500 is intended to show a high level view of many components of the computer system. However, it is to be understood that additional components may be present in certain implementations and furthermore, different arrangement of the components shown may occur in other implementations. System 1500 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 1500 includes processor 1501, memory 1503, and devices 1505-1508 via a bus or an interconnect 1510. Processor 1501 may represent a single processor or multiple processors with a single processor core or multiple processor cores included therein. Processor 1501 may represent one or more general-purpose processors such as a microprocessor, a central processing unit (CPU), or the like. More particularly, processor 1501 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 1501 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 1501, which may be a low power multi-core processor socket such as an ultra-low voltage processor, may act as a main processing unit and central hub for communication with the various components of the system. Such processor can be implemented as a system on chip (SoC). Processor 1501 is configured to execute instructions for performing the operations and steps discussed herein. System 1500 may further include a graphics interface that communicates with optional graphics subsystem 1504, which may include a display controller, a graphics processor, and/or a display device.

Processor 1501 may communicate with memory 1503, which in one embodiment can be implemented via multiple memory devices to provide for a given amount of system memory. Memory 1503 may include one or more volatile storage (or memory) devices such as random access memory (RAM), dynamic RAM (DRAM), synchronous DRAM (SDRAM), static RAM (SRAM), or other types of storage devices. Memory 1503 may store information including sequences of instructions that are executed by processor 1501, or any other device. For example, executable code and/or data of a variety of operating systems, device drivers, firmware (e.g., input output basic system or BIOS), and/or applications can be loaded in memory 1503 and executed by processor 1501. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 1500 may further include IO devices such as devices 1505-1508, including network interface device(s) 1505, optional input device(s) 1506, and other optional 10 device(s) 1507. Network interface device 1505 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 1506 may include a mouse, a touch pad, a touch sensitive screen (which may be integrated with display device 1504), a pointer device such as a stylus, and/or a keyboard (e.g., physical keyboard or a virtual keyboard displayed as part of a touch sensitive screen). For example, input device 1506 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 1507 may include an audio device. An audio device may include a speaker and/or a microphone to facilitate voice-enabled functions, such as voice recognition, voice replication, digital recording, and/or telephony functions. Other IO devices 1507 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. Devices 1507 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 1510 via a sensor hub (not shown), while other devices such as a keyboard or thermal sensor may be controlled by an embedded controller (not shown), dependent upon the specific configuration or design of system 1500.

To provide for persistent storage of information such as data, applications, one or more operating systems and so forth, a mass storage (not shown) may also couple to processor 1501. In various embodiments, to enable a thinner and lighter system design as well as to improve system responsiveness, this mass storage may be implemented via a solid state device (SSD). However in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 1501, e.g., via a serial peripheral interface (SPI). This flash device may provide for non-volatile storage of system software, including a basic input/output software (BIOS) as well as other firmware of the system.

Storage device 1508 may include computer-accessible storage medium 1509 (also known as a machine-readable storage medium or a computer-readable medium) on which is stored one or more sets of instructions or software (e.g., processing module, unit, and/or logic 1528) embodying any one or more of the methodologies or functions described herein. Processing module/unit/logic 1528 may represent any of the components described above, such as, for example, a storage service logic, a deduplication engine, as described above. Processing module/unit/logic 1528 may also reside, completely or at least partially, within memory 1503 and/or within processor 1501 during execution thereof by data processing system 1500, memory 1503 and processor 1501 also constituting machine-accessible storage media. Processing module/unit/logic 1528 may further be transmitted or received over a network via network interface device 1505.

Computer-readable storage medium 1509 may also be used to store the some software functionalities described above persistently. While computer-readable storage medium 1509 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of the present disclosure. The term “computer-readable storage medium” shall accordingly be taken to include, but not be limited to, solid-state memories, and optical and magnetic media, or any other non-transitory machine-readable medium.

Processing module/unit/logic 1528, components and other features described herein can be implemented as discrete hardware components or integrated in the functionality of hardware components such as ASICS, FPGAs, DSPs or similar devices. In addition, processing module/unit/logic 1528 can be implemented as firmware or functional circuitry within hardware devices. Further, processing module/unit/logic 1528 can be implemented in any combination hardware devices and software components.

Note that while system 1500 is illustrated with various components of a data processing system, it is not intended to represent any particular architecture or manner of interconnecting the components; as such details are not germane to embodiments of the present disclosure. It will also be appreciated that network computers, handheld computers, mobile phones, servers, and/or other data processing systems which have fewer components or perhaps more components may also be used with embodiments of the disclosure.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the disclosure also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present disclosure are not described with reference to any particular programming language. It will be appreciated that a variety of programming languages may be used to implement the teachings of embodiments of the disclosure as described herein.

In the foregoing specification, embodiments of the disclosure have been described with reference to specific exemplary embodiments thereof. It will be evident that various modifications may be made thereto without departing from the broader spirit and scope of the disclosure as set forth in the following claims. The specification and drawings are, accordingly, to be regarded in an illustrative sense rather than a restrictive sense.

What is claimed is:

1. A computer-implemented method for encrypting and decrypting data during an active data communication, comprising:
receiving seed data;
extracting a plurality of first seed bits from the seed data;
using the extracted first seed bits to index into a first index location of first one-time pad (OTP) data and obtain system setup random data from the first OTP data;
defining system configuration information including a plurality of cipher parameters based on the system setup random data, wherein the plurality of cipher parameters include encryption cipher parameters and decryption cipher parameters; and
encrypting or decrypting the data based, respectively, at least on the encryption cipher parameters or the decryption cipher parameters to generate encrypted data or decrypted data respectively.

2. The method of claim 1, further comprising:
determining whether the plurality of cipher parameters are to be updated based on a parameter update rate included in the defined system configuration information; and
automatically updating some or all of the plurality of cipher parameters in response to determining that the plurality of cipher parameters are to be updated.

3. The method of claim 2, wherein automatically updating some or all of the plurality of cipher parameters comprises:
using the extracted first seed bits to further obtain, from the first OTP data, a starting index of second OTP data,
using the starting index of the second OTP data to index into a first index location of the second OTP data and obtain one or more first random numbers from the second OTP data, and
updating some or all of the encryption cipher parameters with first new encryption parameter values computed using the one or more first random numbers from the second OTP data.

4. The method of claim 2, wherein automatically updating some or all of the plurality of cipher parameters comprises:
using the extracted first seed bits to further obtain, from the first OTP data, a starting index of third OTP data,
using the starting index of the third OTP data to index into a first index location of the third OTP data and obtain one or more first random numbers from the third OTP data, and
updating some or all of the decryption cipher parameters with first new decryption parameter values computed using the one or more first random numbers from the third OTP data.

5. The method of claim 1, further comprising permanently deleting the first plurality of first seed bits from the seed data.

6. The method of claim 3, further comprising:
again determining whether the plurality of cipher parameters are to be updated based on the parameter update rate included in the defined system configuration information;
in response to determining that the plurality of cipher parameters are to be updated, sequentially retrieving one or more second random numbers from the second OTP data based on a second index location of the second OTP data located immediately after the one or more first random numbers; and
updating some or all of the encryption cipher parameters with second new encryption parameter values computed using the one or more second random numbers from the second OTP data.

7. The method of claim 4, further comprising:
again determining whether the plurality of cipher parameters are to be updated based on the parameter update rate included in the defined system configuration information;
in response to determining that the plurality of cipher parameters are to be updated, sequentially retrieving one or more second random numbers from the third OTP data based on a second index location of the third OTP data located immediately after the one or more first random numbers; and
updating some or all of the decryption cipher parameters with second new decryption parameter values computed using the one or more second random numbers from the third OTP data.

8. A non-transitory machine-readable medium having instructions stored therein, which when executed by a processor, cause the processor to perform operations for, the operations comprising:
receiving seed data;
extracting a plurality of first seed bits from the seed data;
using the extracted first seed bits to index into a first index location of first one-time pad (OTP) data and obtain system setup random data from the first OTP data;
defining system configuration information including a plurality of cipher parameters based on the system setup random data, wherein the plurality of cipher parameters include encryption cipher parameters and decryption cipher parameters; and
encrypting or decrypting the data based, respectively, at least on the encryption cipher parameters or the decryption cipher parameters to generate encrypted data or decrypted data respectively.

9. The non-transitory machine-readable medium of claim 8, wherein the operations further comprise:
determining whether the plurality of cipher parameters are to be updated based on a parameter update rate included in the defined system configuration information; and
automatically updating some or all of the plurality of cipher parameters in response to determining that the plurality of cipher parameters are to be updated.

10. The non-transitory machine-readable medium of claim 9, wherein automatically updating some or all of the plurality of cipher parameters comprises:
using the extracted first seed bits to further obtain, from the first OTP data, a starting index of second OTP data,
using the starting index of the second OTP data to index into a first index location of the second OTP data and obtain one or more first random numbers from the second OTP data, and
updating some or all of the encryption cipher parameters with first new encryption parameter values computed using the one or more first random numbers from the second OTP data.

11. The non-transitory machine-readable medium of claim 9, wherein automatically updating some or all of the plurality of cipher parameters comprises:
using the extracted first seed bits to further obtain, from the first OTP data, a starting index of third OTP data,
using the starting index of the third OTP data to index into a first index location of the third OTP data and obtain one or more first random numbers from the third OTP data, and
updating some or all of the decryption cipher parameters with first new decryption parameter values computed using the one or more first random numbers from the third OTP data.

12. The non-transitory machine-readable medium of claim 8, wherein the operations further comprise permanently deleting the first plurality of first seed bits from the seed data.

13. The non-transitory machine-readable medium of claim 10, wherein the operations further comprise:
again determining whether the plurality of cipher parameters are to be updated based on the parameter update rate included in the defined system configuration information;
in response to determining that the plurality of cipher parameters are to be updated, sequentially retrieving one or more second random numbers from the second OTP data based on a second index location of the second OTP data located immediately after the one or more first random numbers; and
updating some or all of the encryption cipher parameters with second new encryption parameter values computed using the one or more second random numbers from the second OTP data.

14. The non-transitory machine-readable medium of claim 11, wherein the operations further comprise:
again determining whether the plurality of cipher parameters are to be updated based on the parameter update rate included in the defined system configuration information;
in response to determining that the plurality of cipher parameters are to be updated, sequentially retrieving one or more second random numbers from the third OTP data based on a second index location of the third OTP data located immediately after the one or more first random numbers; and
updating some or all of the decryption cipher parameters with second new decryption parameter values computed using the one or more second random numbers from the third OTP data.

15. A communication device, comprising:
a processor; and
a memory coupled to the processor to store instructions, which when executed by the processor, cause the processor to perform operations, the operations including
receiving seed data;
extracting a plurality of first seed bits from the seed data;
using the extracted first seed bits to index into a first index location of first one-time pad (OTP) data and obtain system setup random data from the first OTP data;
defining system configuration information including a plurality of cipher parameters based on the system setup random data, wherein the plurality of cipher parameters include encryption cipher parameters and decryption cipher parameters; and
encrypting or decrypting the data based, respectively, at least on the encryption cipher parameters or the decryption cipher parameters to generate encrypted data or decrypted data respectively.

16. The data processing system of claim 15, wherein the operations further include:
determining whether the plurality of cipher parameters are to be updated based on a parameter update rate included in the defined system configuration information; and
automatically updating some or all of the plurality of cipher parameters in response to determining that the plurality of cipher parameters are to be updated.

17. The data processing system of claim 16, wherein automatically updating some or all of the plurality of cipher parameters comprises:
using the extracted first seed bits to further obtain, from the first OTP data, a starting index of second OTP data,
using the starting index of the second OTP data to index into a first index location of the second OTP data and obtain one or more first random numbers from the second OTP data, and
updating some or all of the encryption cipher parameters with first new encryption parameter values computed using the one or more first random numbers from the second OTP data.

18. The data processing system of claim 16, wherein automatically updating some or all of the plurality of cipher parameters comprises:
using the extracted first seed bits to further obtain, from the first OTP data, a starting index of third OTP data,
using the starting index of the third OTP data to index into a first index location of the third OTP data and obtain one or more first random numbers from the third OTP data, and
updating some or all of the decryption cipher parameters with first new decryption parameter values computed using the one or more first random numbers from the third OTP data.

19. The data processing system of claim 15, wherein the operations further include permanently deleting the first plurality of first seed bits from the seed data.

20. The data processing system of claim 17, wherein the operations further include:
again determining whether the plurality of cipher parameters are to be updated based on the parameter update rate included in the defined system configuration information;
in response to determining that the plurality of cipher parameters are to be updated, sequentially retrieving one or more second random numbers from the second OTP data based on a second index location of the second OTP data located immediately after the one or more first random numbers; and
updating some or all of the encryption cipher parameters with second new encryption parameter values computed using the one or more second random numbers from the second OTP data.

21. The data processing system of claim 18, wherein the operations further include:
again determining whether the plurality of cipher parameters are to be updated based on the parameter update rate included in the defined system configuration information;
in response to determining that the plurality of cipher parameters are to be updated, sequentially retrieving one or more second random numbers from the third OTP data based on a second index location of the third OTP data located immediately after the one or more first random numbers; and
updating some or all of the decryption cipher parameters with second new decryption parameter values computed using the one or more second random numbers from the third OTP data.
